(19) United States
(12) Patent Application Publication
(10) Pub. No.: US 2007/0180136 A1
(43) Pub. Date: Aug. 2, 2007

(54) DISTRIBUTED MULTIMEDIA STREAMING SYSTEM

(75) Inventors: Qiang Li, Campbell, CA (US); Zhen Zeng, Fremont, CA (US); Jifei Song, Fremont, CA (US)

Correspondence Address: UTSTARCOM, INC.;c/o FELIX L. FISCHER, ATTORNEY AT LAW, 1607 MISSION DRIVE, SUITE 204, SOLVANG, CA, 93463, US

(73) Assignee: UTSTARCOM, Alameda, CA (US)

(21) Appl. No.: 11/626,430

(22) Filed: Jan. 24, 2007

Related U.S. Application Data
(63) Continuation-in-part of application No. 10/826,519, filed on Apr. 16, 2004.

(51) Int. Cl. G06F 15/16

(52) U.S. Cl. 709/231

(57) ABSTRACT

A media content distribution system for distributed multimedia streaming communicates over a network and incorporates multiple independent media stations, each having a media director for control and a number of media engines for storage, retrieval and streaming of media content. A content request from a media console connected to the network is redirected by the media director to a selected one of the media engines storing content corresponding to the request for streaming. Statistical indicators are defined for measuring effectiveness of the content distribution network. Push and pull indicators with additional differentiation for remote and local access to pulled content provide means for efficiency determination of data distribution and storage. A middleware Application Programming Interface (API) structure is provided for flexible interfacing between media consoles and content distribution system components.

### REFERENCE TO RELATED APPLICATIONS

This application is a continuation-in-part of U.S. patent application Ser. No. 10/826,519 filed on Apr. 16, 2004 entitled METHOD AND APPARATUS FOR A LARGE SCALE DISTRIBUTED MULTIMEDIA STREAMING SYSTEM AND ITS MEDIA CONTENT DISTRIBUTION and having a common assignee with the present application.

### FIELD OF THE INVENTION

This invention relates generally to the field of distributed multimedia streaming and more particularly to media content distribution with performance measurement of content distribution and middleware APIs for enabling service functions which facilitate interaction between a media console or IPTV terminal and other network components in the distributed system.

### BACKGROUND OF THE INVENTION

High bit rate multimedia streaming, particularly high bit rate video streaming has evolved from handling thousands of simultaneous subscriber to millions of subscribers. The conventional system architecture based on a single powerful machine or a cluster system with central control can no longer meet the massive demands.

One of the most important aspects of a content distribution network is its effectiveness, i.e. how it performs better than centralized system and how different content distribution networks perform against one another. To help measure effectiveness of content distribution, a set of quantified indicators is needed.

Additionally, traditional telecom message based interfaces and the related interoperability between a media console or IPTV terminal and the content distribution system becomes a bottleneck restricting new service introduction and development. The messaged based interoperability is inflexible, and is unable to expediently support new service development. A middleware based interoperability between IPTV terminal and distributed components of the IPTV system is therefore desirable to provide a flexible and expandable solution. This is also desirable to allow application vendors to conveniently develop various new service and applications without paying attention to the detailed parameter and message format of the interface, and reduce the time-to-market to launch new services.

### SUMMARY OF THE INVENTION

A media content distribution system for distributed multimedia streaming communicates over a network and incorporates multiple independent media stations, each having a media director and a number of media engines. Each media engine includes storage for media content, retrieval systems to obtain media content over the network and interconnection for streaming media content over the network. The media director controls the media station and is employed for directing retrieval over the network of media content by a selected media engine and tracking content stored on the media engines. A content request from a media console connected to the network is redirected by the media director to a selected one of the media engines storing content corresponding to the request for streaming.

At least one distribution center communicating over the network is provided and includes media content downloading capability and a media location registry communicating with the media director in each media station. The media location registry stores the location of all media content in the media stations.

Statistical indicators are defined for measuring effectiveness of the content distribution network. Push and pull indicators with additional differentiation for remote and local access to pulled content provide means for efficiency determination of data distribution and storage. In an exemplary embodiment the communications network includes means for pushing media content and a plurality of independent media stations communicate with the network, each having means for storing pushed media content locally, means for retrieving remotely stored media content over the network as pulled content and means for streaming media content over the network, and means for directing a content request from a media console connected to the network for streaming from stored content. measuring efficiency of pushed and pulled content is accomplished by measuring number of requests satisfied by pushed contents, measuring number of requests satisfied by pulled contents; and measuring number of unsatisfied requests for locally present contents In alternative embodiments the efficiency measurement further includes measuring number of requests satisfied by pulling remote contents; measuring number of unsatisfied requests for remote contents; and calculating the number of requests for remote contents. Measuring number of push sessions and calculating the efficiency of push session as a ratio of number of requests satisfied by pushed contents and the number of push sessions are also provided. Similarly, measuring the number of pull sessions and calculating an efficiency of pull sessions as a ratio of number of requests satisfied by pulling remote contents and the number of push sessions. Finally, the means for measuring efficiency in certain embodiments includes measuring a number of pulled bytes; measuring a number of pushed bytes; measuring a number of served bytes; and calculating an efficiency of push/pull as a ratio of the sum of the number of pulled bytes and the number of pushed bytes to the number of served bytes.

A middleware Application Programming Interface (API) structure is provided for flexible interfacing between media consoles and content distribution system components. For the embodiment disclosed herein, a plurality of application programming interface (API) modules are provided for Security and Authentication management; upgrade and download; media play and control; Digital Rights Management (DRM) terminal management; and, Information display and control.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the layer architecture of an exemplary media switch system employing the invention;

FIG. 2 is a block diagram of the hardware elements for implementing the layers of FIG. 1;

FIG. 3 is a block diagram of the logical hierarchy for content distribution in a system employing the invention;

FIG. 4 is a block diagram of the elements incorporated in an exemplary media station;

FIG. 8a is a diagram of the hardware interaction and process for streaming data to a subscriber's media console;

FIG. 8b is a flow diagram of the process for streaming data as shown in FIG. 5a;

FIG. 9 is a flow diagram of the process for rapid replication of segments on alternative media engines to relieve overload;

FIG. 10 is a flow diagram of the process for media engine swapping for avoiding errors in response to subscriber commands;

FIG. 11 is a flow diagram of the process for deletion of programs from the media stations;

FIG. 12a is a block diagram of the high level data flow for the integrated media switch incorporating the invention;

FIG. 12b is a block diagram of Statistical indicators for measuring effectiveness of the content distribution network;

FIG. 13 is a top level block diagram of the hardware physical structure;

FIG. 14 is a detailed block diagram of the chassis arrangement;

FIG. 15 is a block diagram of the functional interaction of the blade main board with the Network Management System and the chassis blade controller;

FIG. 16 is a block diagram of the basic elements of the secret key system for access control in a system employing the invention;

FIG. 17 is a block diagram of the system communication for authentication of a media console request for streaming data; and

FIG. 18 is a block diagram of middleware API elements for system operation.

### DETAILED DESCRIPTION OF THE INVENTION

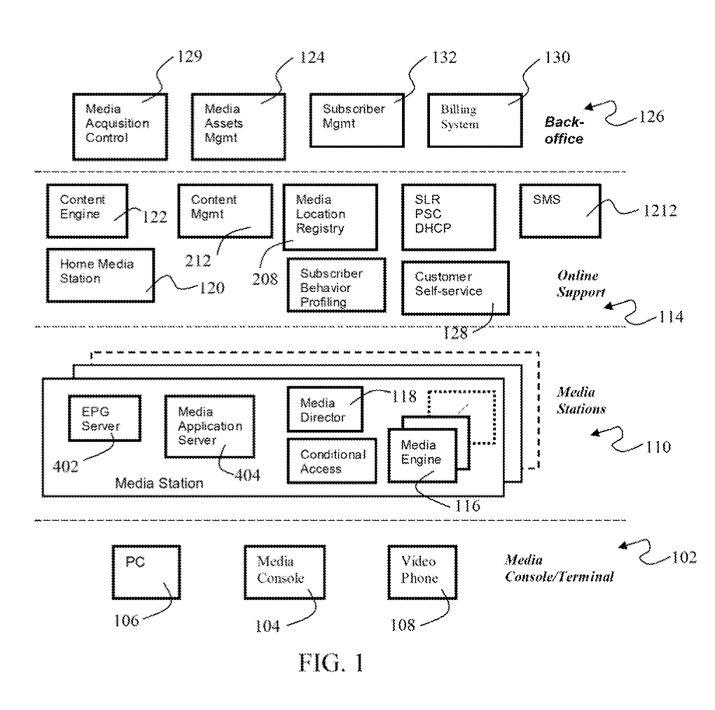

A media content distribution system incorporating the present invention employs two tiers, a media station that covers a district, and the media switch, consisting of a number of media stations, that covers a metropolitan area or several metropolitan areas. FIG. 1 is an architectural overview showing the layers in which the system operates. Beginning with the media console/terminal layer 102, media consoles 104 or terminals are the end devices for media streaming operations and provide content to the subscriber. A typical device has an Electronic Program Guide (EPG) agent which displays the program guide, a decoder decoding compressed streaming data such as MPEG-2, MPEG-4, and Microsoft Windows Media Series 9, a Media Player which interacts with streaming servers to control the program selection, trick-mode operation (“VCR like” operations such as fast forward, pause and rewind), and data flow. In the case of Media Console, a TV encoder is built in to convert the streaming data into TV signals. In many applications a personal computer 106 and a video phone 108 will be attached to the network at the subscriber level.

The media station layer 110 provides multiple media stations for data streaming. A Media Station 112 is a self-sufficient streaming unit communicating with a set of subscribers having media consoles/terminals. Media Stations are typically installed in a Central Office (CO) in a broadband network. The placement of Media Stations is determined according to the number of customers to be covered, network topology, and available bandwidth of the backbone network.

As will be described in greater detail subsequently, a Media Station has sufficient storage to store most frequently accessed programs and associated metadata. A subscriber's streaming request is sent to a Media Station. The Media Station will take appropriate actions and start the stream. Other requests from the subscriber such as trick-mode operations and EPG navigations are also sent to Media Station.

Media Stations interact with the Online Support Layer 114 to obtain subscriber information, content management information, billing related information, and EPG related information. They also interact with the Online Support Layer as well as other Media Stations to copy or move program data among the Media Stations and between a Media Station and the Data Center.

Each Media Station has a number of Media Engines 116. A Media Engine can be a blade in a chassis as will be described in greater detail subsequently. The Media Engine is responsible to streaming program data to the subscribers. The specific configuration of the Media Engine depends on the number of subscribers covered and the amount of program data stored in the Media Station.

A Media Director 118 is the control unit of a Media Station. All subscribers' initial streaming requests are sent to Media Director. In addition, the Media Director controls load balance, storage balance, and media data replication within the Media Station. In certain hardware applications as described in greater detail subsequently, one of the Media Engines will be used as a backup Media Director. It mirrors data from the Media Director during normal operation and takes over the role when the Media Director is out of service.

An Online Support layer 114 manages content information for the entire Media Switch system and controls the media data distribution among Media Stations. In exemplary embodiments, the Online Support layer also provides billing and subscriber management services to Media Stations and network management functions.

A Home Media Station 120 in the online support layer stores media data for all programs that are currently in service. A Content Engine 122 in this layer is the introduction point for media data into the system. The Content Engine obtains instructions from the Media Assets Management System (MAM) 124 in the back-office layer 126 and performs necessary encoding, trans-coding, or uploading from various sources such as digital video tapes, DVD, live TV, etc., stores this data in the Home Media Station and distributes it to the Media Stations in the media station layer.

A Customer Self-service system 128 is also incorporated into the online support layer, through which a customer can check account status, pay subscription fees, purchase service plans for special programs, register service requests, as well as configure EPG settings.

The back office layer 126 provides offline support operations and generation of control data for the other layers. The Media Assets Management (MAM) system 124 is used to keep track of and control the life cycle of each media program. It assigns a system-wide unique Program ID for each new media program, and generates work orders for the Media Acquisition Control module 128, which in turn interacts with a human operator to start and control the operation of Content Engine in the online support layer. A Billing System 130 and the Subscriber Management System 132 manage back-end databases, and support user interfaces for setting up billing policies and entering or modifying subscriber information.

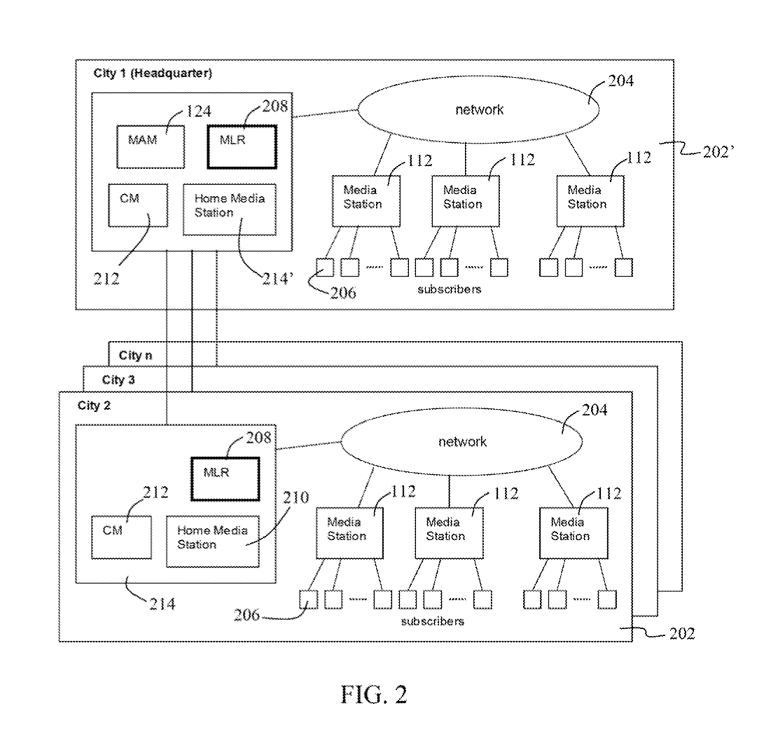

FIG. 2 demonstrates one embodiment of the multiple layers of the Media Switch configured for use in a number of geographical areas or cities 202 served. Each city employs a series of media stations 112 interconnected through the metropolitan area network (MAN) 204. Each media station serves a number of subscribers 206. Each subscriber has a fixed media station to serve its streaming requests. Additionally, each city incorporates on-line support layer elements including a media location registry (MLR) 208, a home media station 210 and a content manager 212 in a distribution center (DC) 214. For the embodiment shown, a principal city 202′ is chosen as a headquarters site. Associated with that site is the MAM 124. In alternative embodiments, multiple cities incorporate a MAM for introduction of content into the system.

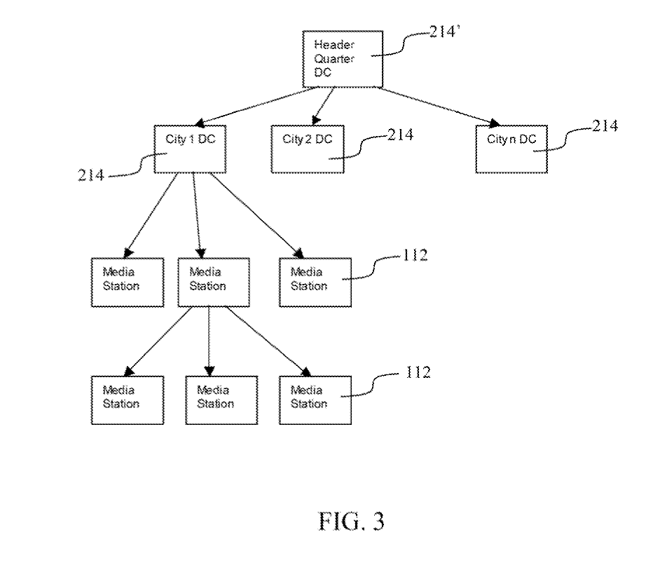

The MAM determines when and where to distribute a program. The CM publishes the program at the time specified by the MAM and the MLR identifies the location of the data for distribution. Logically, the resulting content distribution system is hierarchical as shown in FIG. 3. The Headquarters distribution center 214′ provides content to the various city distribution centers 214. Each city DC then distributes the data to the media stations 112 in its control and media stations further distribute data to other media stations as will be described in greater detail subsequently.

As previously described, a media station is a self-sufficient streaming unit covering a set of subscribers. Media stations in a typical application are installed in a CO of a broadband network. The placement of media stations is determined according to the number of subscribers to be covered, network topology and available bandwidth of the network.

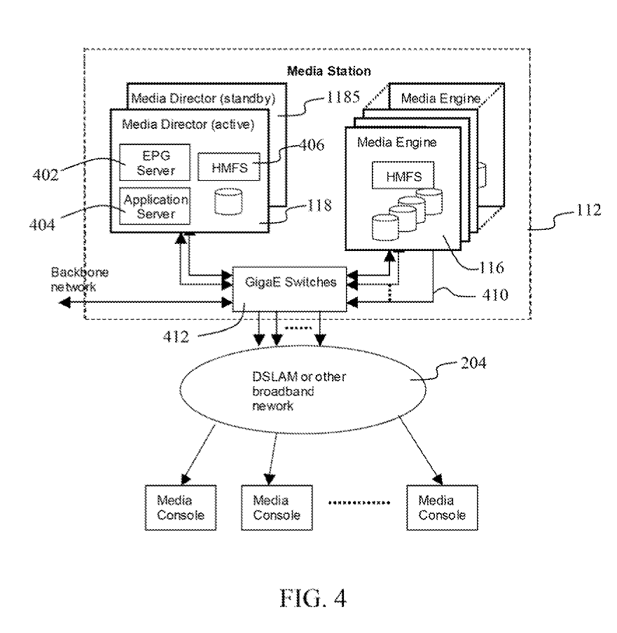

As shown in FIG. 4 for an exemplary embodiment, each media station 112 incorporates a media director 118 having an EPG server 402 and an application server 404 for handling streaming and trick requests from the subscriber. A Hyper Media File System (HMFS) 406 is incorporated for data storage. A standby media director 118S with identical capabilities is provided to assume the role of the active director upon failure or removal from service. Multiple media engines are present in the media station. The media director records the location of all programs in the system and which media engine holds a particular program or portions of it. Upon communication from a subscriber media console, the media director directs the media console to the appropriate media engine to begin the data stream. A distributed storage subsystem (for the embodiment shown, a HMFS) 408 is present in the media engine to employ large number of independent, parallel, I/O channels 410 to meet massive storage size demands and I/O data rate demands. Media engines are connected together through a set of Gigabit Ethernet switch 412, and to the network 204 communicating with the subscribers. Matching bandwidth between the network to subscribers and I/O channels avoids any bottleneck in the streaming system.

Each media program (a movie, a documentary, a TV program, a music clip, etc.) is partitioned into smaller segments. Such partition provides a small granularity for media data units and makes data movement, replications, staging and management much easier and more efficient. Distribution of the content to the media stations is accomplished as shown in FIG. 5.

A new program is loaded and distributed by the MAM transferring metadata 502 of the new program to Content Manager (CM) 212. The MAM then instructs Content Engine (CE) 122, by means of a work order 504, to transfer the program data 506 into Home Media Station (HMS) 120. The MAM updates the state of the program to “inactive” and specifies a publish time 508. The MAM sends distribution parameters 510 to the MLR to trigger the distribution of the program 512. The MLR starts the operation sequence to distribute contents to Media Stations 112 as will be described in greater detail subsequently. The CM sends the “publish” commands to all Media Stations at a specified time to start the service of the program 514.

To provide content to the media stations to be available for subscriber access, content is “pushed” to the media stations as shown in FIG. 6. The “push” operation is directed by the MAM/MLR to send selected media to media stations to be available for streaming requests. The push decision is based on anticipated usage and is modified or updated by analytical methods as described herein subsequently. The MLR directs the media director MS2MD in a media station MS2 to obtain the program 602, identifying a media station MS1 where the content is present. Initially, the content will be present in the Home Media Station and subsequently in the logical hierarchy as previously described with respect to FIG. 3. The media director in the seeking media station MS2 will then request the location 604 of the needed segment from the media director MS1 MD of the identified station. The identified MD will then notify 606 the seeking MD of the location of the segment in media engine MS1ME. The seeking MD will then direct 608 an appropriate media engine MS2ME to fetch the segment from MS1ME. The MS2ME will request 610 a copy of the segment from MS1ME and MS1ME will respond 612, transferring the segment. When the copying of the segment is complete, MS2ME will notify MS2MD that the copying of the segment is complete 614. The media director then notifies 616 the MLR of the new location of the segment for addition to the location database.

The MLR can plan the push sequence from Media Station to Media Station so the push operation can be done in shortest time to all Media Stations. For example, the logical tree structure shown in FIG. 3 is employed by directing all Media Stations at the top level to get the segments from Home Media Station, and then directing the next level Media Stations to get the segments from their group leaders. For an exemplary embodiment, the first segment of all active programs is distributed to all media stations to simplify access for the subscribers.

For content which is not yet present on a media stations but published for distribution as shown in FIG. 5, a request from a subscriber results in transfer or “pull” of the content as shown in FIG. 7. A content “pull” is initiated by a streaming request for media not yet present unlike “pushed” segments which are provided to the media station by the MAM/MLR as previously described. The subscriber media console 104 makes a streaming request 702 to the media director MS2 MD of the media station MS2. The MD asks 704 the MLR for the location of the program or segment requested. The MLR responds with a notification 706 of locations for the segment. Multiple locations may exist where the desired segment is stored. The MD calculates the relative cost of obtaining the desired copy of the segment based on a number of parameters including the bandwidth available, distance from the source media station, copying time and load of the source media station. Upon selection of a source media station, MS1 for the example herein, the MD requests 708 the location of the segment from MS1MD which responds 710 with the address of a media engine MS1ME storing the segment. MS2MD then directs 712 a selected media engine MS2ME to fetch the segment. MS2ME requests 714 a copy of the segment from source media engine MS1ME which responds 716 sending the segment. Upon completion of the copying of the segment, MS2ME notifies 718 the MD of completion of the copy and the MD notifies 720 the MLR of the new location of the segment.

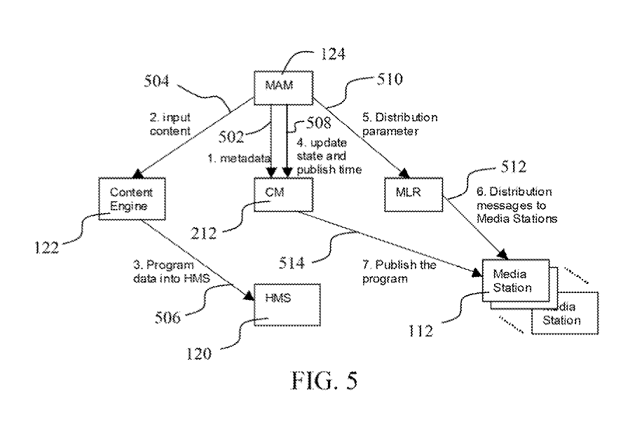

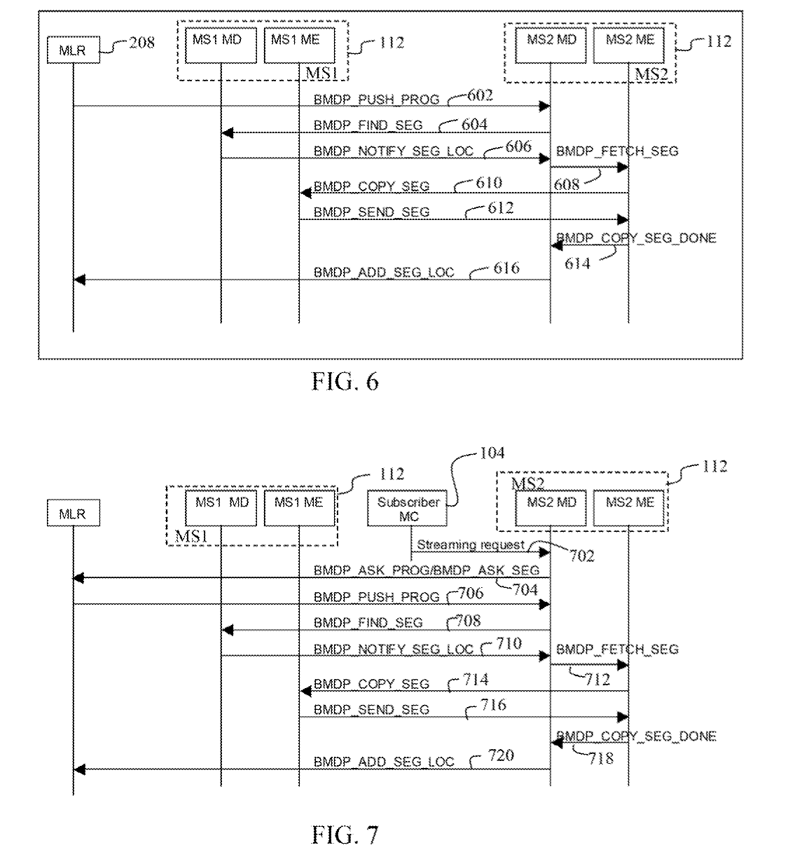

For streaming content to subscribers, the media director in each of the media stations employs a load balancing scheme to keep track of the task load of the media engines in the media station. Load balance is achieved by directing streaming requests according to current system states and load distribution. An example of the communications sequence for data transfer under the command of the media director is shown in FIG. 8a with representative IP address locations for the system elements. The media console 104 requests 802 a segment 0021 from the media director 118. The media director identifies the location of the segment in a segment location table 804 as present in media engines 1 and 8, (ME1 and ME8) and redirects 806 the MC to ME1's IP address 10.01.1.11. The MC then requests 808 segment 0021 from ME1 which begins streaming data 810. When the segment being streamed nears its end, ME1 requests 812 the location of the next segment from the MD which locates the next segment and MEs storing that segment in the segment location table, selects an ME based on load and status and replies 814 with the identification of the next segment (seg 0022) and the IP address 10.0.1.12 of ME2 where the next segment resides. ME1 notifies ME2 to preload 816 the next segment seg 0022 and upon completion of the streaming of seg 0021 directs 818 ME2 to start streaming seg 0022 to IP address 18.0.2.15, the media console. ME2 then begins streaming 820 the data from seg 0022 to the MC.

A flow diagram of the sequence described with respect to FIG. 8a is shown in FIG. 8b. Upon assumption of the communication of the stream with the MC by ME2, ME2 sends a notification 822 to the MD. The process described continues until the MC orders a cessation of streaming 824 by the ME at which time the ME notifies the MD the streaming has stopped 826.

As a portion of the load balancing scheme, a rapid replication scheme is used to copy a segment from one media engine to another. When a media engine exceeds its capacity of streaming, a highly demanded segment can be replicated to another media engine and further requests for that segment are directed to the new media engine. The extra delay observed by the streaming request that triggered the replication is less than 30 milliseconds in exemplary embodiments.

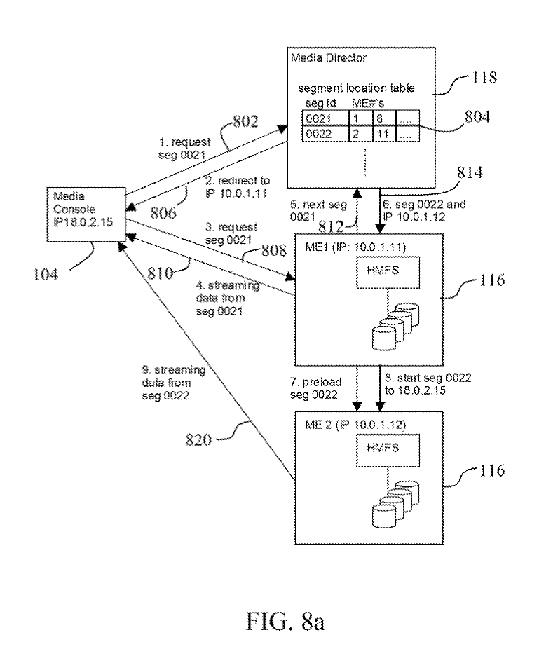

The communications sequence is shown in FIG. 9. A first media console MC1 requests streaming 902 of a segment to the media director MD. The MD replies 904 with a redirection to a media engine ME1 storing the segment. MC1 requests playing of the stream 906 from ME1 and ME1 responds 908 by streaming the RTP packets of data from the segment. The MD has cataloged the redirection to ME1 and monitors ME1's load. If ME1 has reached a predetermined maximum capacity, when another media console MEn requests streaming 910 of the same segment, if the segment is not present on another available ME in the segment location table, the MD directs 912 another media engine ME2 to fetch the segment and specifies the ME from which the segment is to be replicated. In various embodiments the maximum capacity may be determined such that the replication can occur from the first media engine or other existing media engines in the segment location table. Alternatively, the fetch command may direct copying of the segment from a media engine in another media station as described with respect to FIG. 7. For purposes of the example, the source media engine defined by the MD is designated MEx. ME2 requests a copy 914 of the segment from MEx which replies by sending the segment 916. Upon direction of the fetch, the MD replies 918 to MCn redirecting to the IP address of ME2. MCn then requests playing of the stream 920 and ME2 responds 922 forwarding RTP packets for the segment to MCn. When copying of the segment from MEx to ME2 is complete, ME2 sends a copy done 924 to the MD which notifies the MLR of the new location for the segment as previously described.

A stream swapping method is used to exchange two streams of the same segment, one on a first media engine ME2 that has a complete copy of the segment and a second on a second media engine ME1 which is currently receiving the same segment. Where the subscriber attempts a fast-forward while streaming from ME1 with the incomplete segment, the media director swaps the fast-forwarding stream from ME1 to ME2 (with the complete segment). The stream using the same segment running at normal rate is swapped from the first media engine to the second media engine thereby avoiding a failure of the fast forwarding operation.

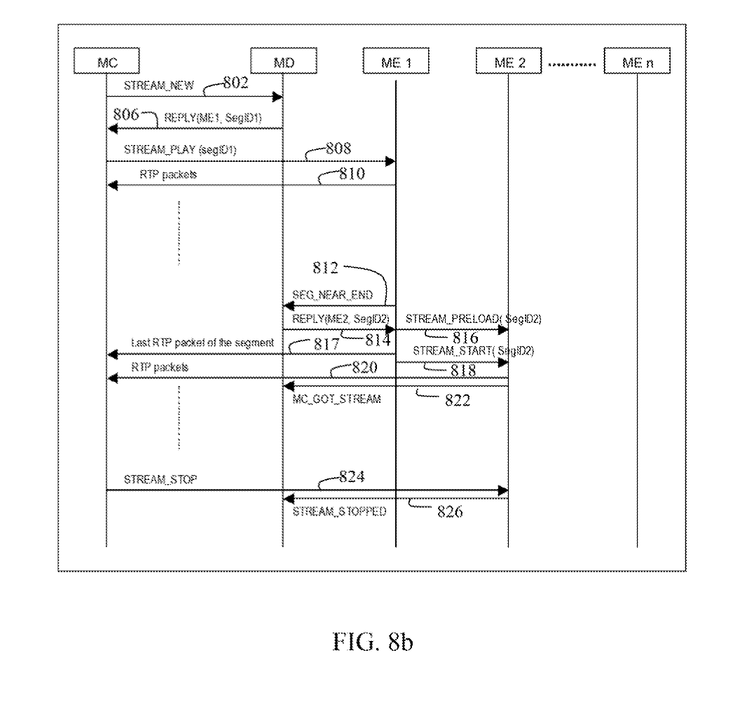

FIG. 10 demonstrates the communications sequence for swapping media engines. During normal operation, the media director MD has directed ME1 to fetch 1002 a particular segment. ME1 requests a copy 1004 of the segment from the source ME (arbitrarily identified as MEx) and MEx responds by sending 1006 the desired segment. During receipt of the segment, a media console MC1 requests a stream 1008 from the MD which replies 1010 redirecting the MC to ME1. MC1 requests playing of the stream 1012 and ME1 responds 1014 by sending the RTP packets from the requested segment. If MC1 requests a fast forward 1016 of the stream (segment) ME1 identifies the potential for a streaming error if the fast forward exceeds the portion of the segment which has been received from MEx. ME1 notifies 1018 the MD of the impending error state and the MD replies with the identification of a media engine ME2 (which can be MEx itself) having the entire segment that is idle or has started streaming after ME1. ME2 has been streaming RTP packets 1020 of the segment to another media console MCn. ME1 requests a swap 1022 identifying MC1 as the media console in current communication and providing the segment number and frame within the segment. ME 2 begins streaming of data 1024 from the segment to MC and, if ME2 has been streaming, returns a swap 1026 identifying media console MCn and the frame of the segment. ME1 takes over streaming of RTP packets 1028 to MCn.

The media engines in the media station are symmetrical with respect to input and output thereby allowing data to be taken into the media engine substantially as rapidly as streaming data is sent out. Therefore, the media station can be used as a high bit rate, massive storage repository. This architecture is specifically beneficial in live broadcast transmission where the program segments are transferred to the media stations in real time and streamed to the media consoles. Details of an embodiment of the media stations employed in the present invention are disclosed in copending patent application Attorney Docket No. U001 100085 entitled METHOD AND APPARATUS FOR A LOOSELY COUPLED, SCALABLE DISTRIBUTED MULTIMEDIA STREAMING SYSTEM having a common assignee with the present application, the disclosure of which is incorporated by reference as though fully set forth herein.

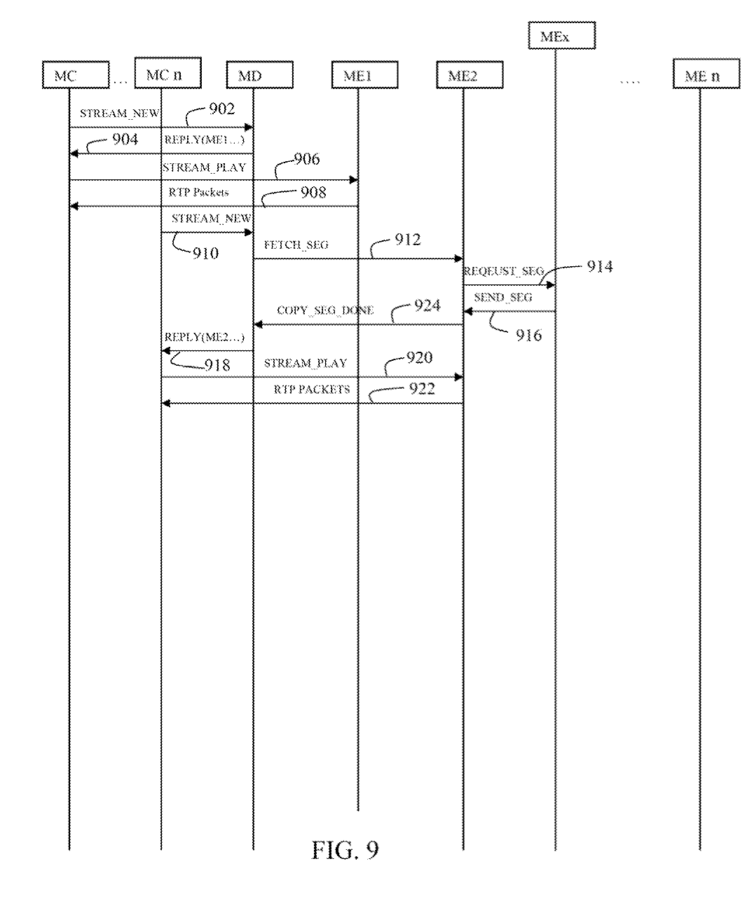

In addition to acquiring program segments, segments which are not requested from a media station will age out and be removed. FIG. 11 provides an exemplary communication flow for removal of an unused program/segment. Upon determination that a program has timed out or additional storage space is necessary for higher usage programs, the media director MS1MD requests deletion of the program 1102 to the media location registry MLR. MLR responds with an approval of the program deletion 1104 and the MD generates and internal deletion message 1106 to the media engine(s) MS1ME in the station which the segment location table indicates have the segments associated with the program. The media director then sends a message 1108 to the MLR confirming the deletion for the MLR to update the location database.

In certain instances, it is desirable to retain one copy of a program being deleted by media stations for storage reasons. This instance is also shown in FIG. 11 where media station 1 is deleting a program to free up storage but the MLR determines that saving the program is desirable and directs transfer of the program to a media station having surplus storage availability. MS1MD requests deletion of a program 1110 to the MLR. The MLR directs a program move 1112 to the media director MS2MD in a second media station, identifying the media station currently requesting the deletion. MS2MD queries MS1MD to find the segment(s) 1114 associated with the program and MS1MD responds 1116 with the segment location(s). MS2MD directs a media engine MS2ME to fetch the segment(s) 1118. MS2ME sends a copy request 1120 to MS1ME which responds by sending the segment(s) 1122. MS2ME notifies 1124 MS2MD when copying of the segment(s) is complete and MS2MD notifies 1126 the MLR of the new segment location. This process is repeated until all segments of the program are transferred at which time MS2MD notifies MS1MD that the move has been completed 1128. MS1MD then again requests deletion of the program 1130 from the MLR which responds with an approval 1132. MS1MD then sends internal deletion messages 1134 to MS1ME to delete the program segments and notifies the MLR that the program deletion is complete 1136 for updating the location database.

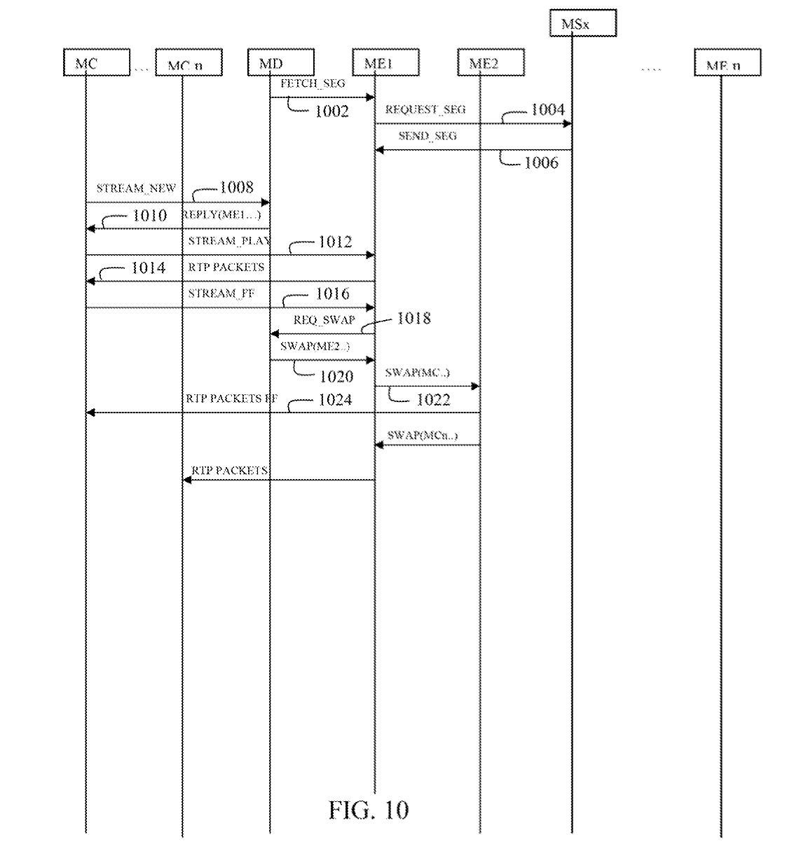

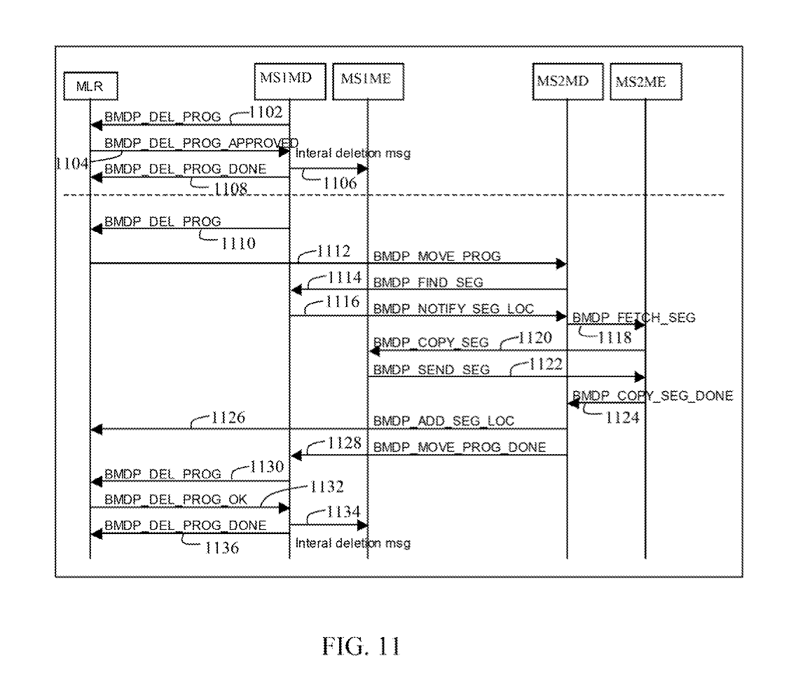

High level data flow for the overall media switch is shown in FIG. 12a. Original content is made available by a content provider 1202. The controller uses the MAM User Interface (UI) 1204 to direct the MAM to interface with the content provider to receive the content. Under control of the MAM, the content engine 122 prepares and encrypts the program in segments and distributes the content to the Home media station 120 and the content manager 212 stores the metadata for the content in a database 1206. The location of the content is stored by the media location registry 208 in the media location management database 1208. The content manager provides the content metadata to the EPG and Access control elements 402 of each media station 112 for storage in their database 1210 as previously described. The Home media station transfers data to the media engines in the media station under the control of the media director for storage as previously described.

Statistical indicators for measuring effectiveness of the content distribution network are shown in FIG. 12b. These indicators are calculated and stored by the media directors (MD) and/or the Media Assets Management System (MAM) for the embodiment described herein. Number of requests for contents 1232 indicates the amount of load on the system from user media consoles. The greater the number, the higher the demand for the measured segment. Number of requests satisfied by pushed contents 1234 is determined by pushed contents which are those contents that became locally present as result of push operations previously described. The greater proportion this number accounts for among total number of requests, the more effective the content push is. Number of requests satisfied by pulled contents 1236 comprises the number of requests for contents that became locally present as result of pull operation. The greater proportion this number accounts for among total number of requests, the more effective the content pull is.

Number of requests satisfied by pulling remote contents 1238 is defined by remote contents are not locally present and become locally present as result of the pulling operation triggered by the request. These are the requests that triggered pulling operation. The smaller proportion this number accounts for among total number of requests, the more effective the content push is. An alternative criterion, Number of requests satisfied by locally present contents 1240, is determined by locally present contents including pushed contents and pulled contents. The greater proportion this number accounts for, the more effective the combination of push and pull is. The value of Number of requests satisfied by locally present contents 1242 is the sum of Number of requests satisfied by pushed contents 1234 and Number of requests satisfied by pulled contents 1236.

Number of requests for remote contents 1246 is measured and the smaller proportion this number accounts for among total number of requests, the more effective the content push is. Number of unsatisfied requests for remote contents 1248 is created when the system is overloaded and requests cannot be satisfied regardless of whether the content is locally present or remote. Since content distribution is one of the contributors to system load, the smaller proportion this number accounts for among total number of requests, the less intrusive the overall content distribution is. The value of Number of requests for remote contents 1246 should be sum of Number of requests satisfied by pulling remote contents 1238 and Number of unsatisfied requests for remote contents 1248.

Similarly, Number of unsatisfied requests for locally present contents 1250 is also measured since when the system is overloaded these requests also can not be satisfied regardless of whether the content is locally present or remote. As with unsatisfied requests for remote contents, since content distribution is one of the contributors to system load, the smaller proportion this number accounts for among total number of requests, the less intrusive the overall content distribution is.

The total number of requests, Number of requests for contents 1232, should be sum of Number of requests satisfied by pulling remote contents 1238, Number of requests satisfied by locally present contents 1240, Number of unsatisfied requests for remote contents 1248 and Number of unsatisfied requests for locally present contents 1250.

Number of push sessions 1252 is measured to provide a ratio with Number of requests satisfied by pushed contents 1234 to indicate the effectiveness of content push 1254. The greater the ratio, the more requests a push session satisfies therefore more effective.

Similarly, Number of pull sessions 1256 is measured. A request for remote content may trigger multiple pull sessions. The ratio between Number of requests satisfied by pulled contents 1236 and Number of pull sessions 1256 indicates the effectiveness of content pull 1258. The greater the ratio, the more requests a pull session satisfies, therefore more effective it is.

To measure the total push traffic generated by the content distribution network and the total pull traffic generated by the content distribution network, Number of pushed bytes 1260 and Number of pulled bytes 1262 are measured.

The number of bytes actually consumed by users—the effective bytes, is measured by Number of served bytes 1264. The sum of Number of pushed bytes 1260 and Number of pulled bytes 1262 indicates the number of bytes made available to users. The ratio between the effective bytes and the available bytes indicates effectiveness of content push and pull 1266. The greater the ratio is, the more effective the content push and pull are. The statistical measurements discussed herein are employed for analysis and modification of the storage requirements for the media stations and the amount and timing of cached data for content segments using the various system elements as described to maximize the system efficiency.

Returning to FIG. 12a, the subscriber management system 1212 maintains data on subscribers in a subscriber database 1214 and communicates through a cache 1216 with an authentication server 1218 and a customer self care system 1220. The authentication server communicates with the subscriber's media console 104 as the first step in data streaming. When a subscriber selects a program to be obtained by using the EPG functions in the media console, a request is made from the media console to the authentication server which authenticates the subscriber and provides service tokens. The service tokens are then passed by the media console to the access control function of the media station. The media director then provides the program segments to the media console through the media engine as previously described.

An integrated billing system 1222 operates similarly through the cache 1216 providing billing data to a distributed billing function 1224 within the media stations, each having a subscriber and billing cache 1226 for data storage. Billing information is then transmitted to the media console for the subscriber.

The customer self care system is also accessible by the subscriber through the media console. The customer self care system communicates through the cache to the billing and subscriber management systems.

A network management system (NMS) 1228 enables control of the hardware elements of the entire system. An exemplary NMS would be UTStarcom's MediaSwitch NMS.

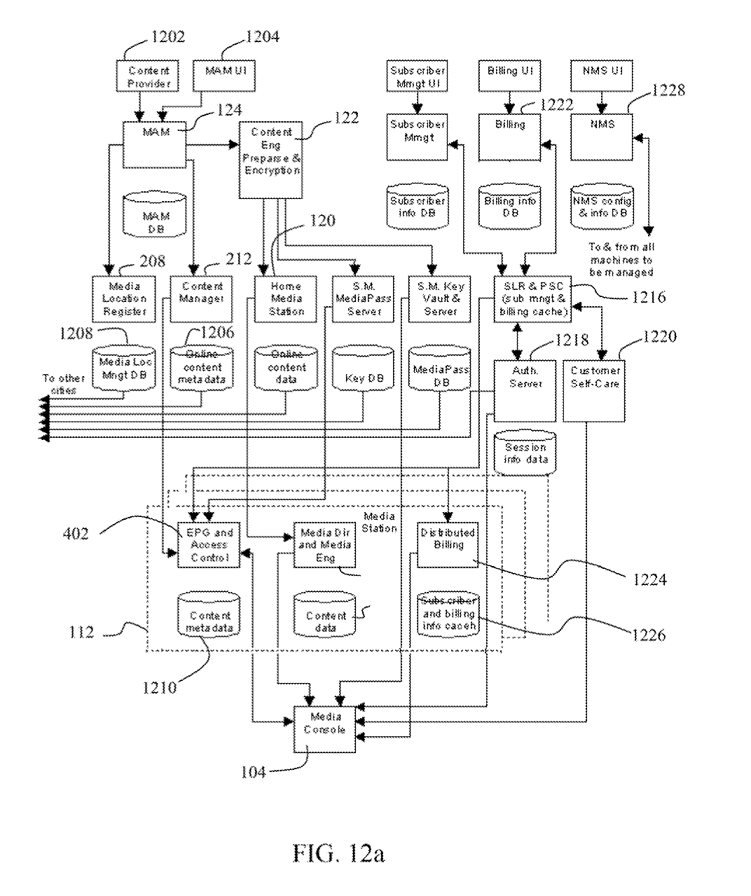

From a hardware standpoint in a representative embodiment, the Media Switch system is hierarchical with four tiers; the entire system as represented in FIGS. 2 and 12, as previously described, the Media Station, the chassis, and individual blades. From the top level as shown in FIG. 13, the Network Management System (NMS) 1228 in a central location covers a city, a country, or even multiple countries. The second tier is the Media Station (MS) 112, a self-contained streaming unit typically located in a CO and covering the vicinity of the CO. Each MS consists of a number of chassis 1302, the third level of management. The chassis management system provides external control for the blades in the chassis. The blade 1304 is the lowest level management unit. Each blade is an independent computer. It can be either a Media Engine (ME) or a Media Director (MD).

In the embodiment shown, the Media Station is a level of abstraction, with its state represented by its MD. Therefore, the MS is not an entity in the management structure and a three-tier management system is employed.

Network management is the first level and provides a full set of management functionalities and GUI. System load and other operational parameters such as temperature and fan speed are monitored. Automatic alarms can be configured to send email or call to the system operator.

Chassis management is the second level and provides blade presence detection, automatic blade power up, remote blade power up and power down, managed blade power up to avoid current surge during disk drive spin up, chassis id reading and chassis control fail-over.

Blade self-management and monitoring is the third level and allows temperature, fan speed, and power supply voltage monitoring and alarm through SNMP to the NMS, self-health monitoring including critical threads monitoring, storage level monitoring, load monitoring, etc. All alarm thresholds can be set remotely by NMS. For software related failures, software restart or OS reboot will be attempted automatically, and the event will be reported to NMS.

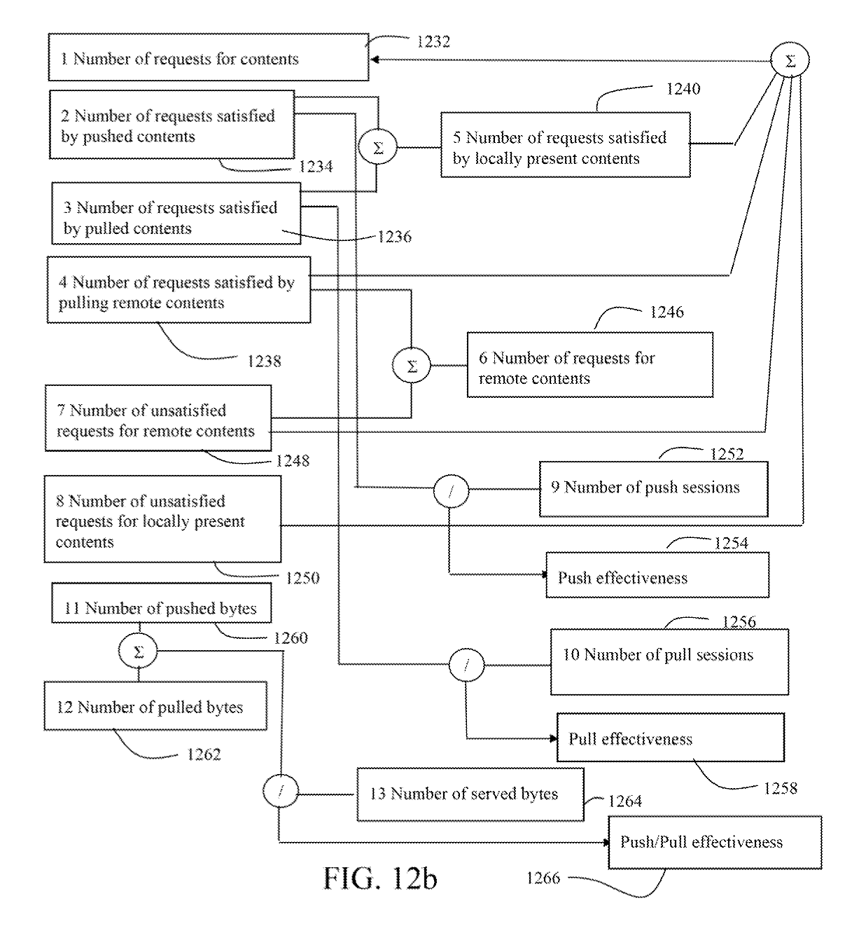

As shown in FIG. 14 for the exemplary embodiment, a chassis can host up to 10 blades 1304, each can be a Media Engine or a Media Director. Each blade can read the chassis ID 1402 and its own slot number 1404 for identification.

All blades in a chassis are equipped with a control unit or Chassis Blade Controller (CBC) 1406. For the exemplary embodiment, each CBC consists of an Intel 8501 chip implementing the control logic and an FPGA configured to act as the control target. The 8501 chip also communicates with the main board 1408 through a UART interface 1410. The main board can issue control commands or relay control commands received from NMS through the network to the CBC.

For the exemplary embodiment, blades located in slot 5 and 6 are the control blades. One active and one standby determined by the arbitration logic at power up. When the chassis is being powered up, the blades in slots 5 and slot 6 arbitrate and one becomes the active controller. The CBC on the active control blade scans the back-plane and powers up the blades in a controlled sequence with a pre-determined interval to avoid current surge caused by disk drive spin up on the individual blades.

The CBC on the active control blade then scans all slots on the backplane and detects the presence and status of each blade. The standby control blade monitors the status of the active control blade. When the active control blade gives up the control, the standby automatically takes over and become the active control blade.

During normal operation, the CBC on the active control blade periodically scans the backplane. If a new blade is plugged in, it will be automatically powered up.

The active control blade register itself with NMS, and can take commands from NMS for controlling other blades in the chassis, such as checking their presence and status, power up/down or power cycle a blade, etc. The non-controlling blades also register themselves to NMS and can take commands from NMS to reboot or power down.

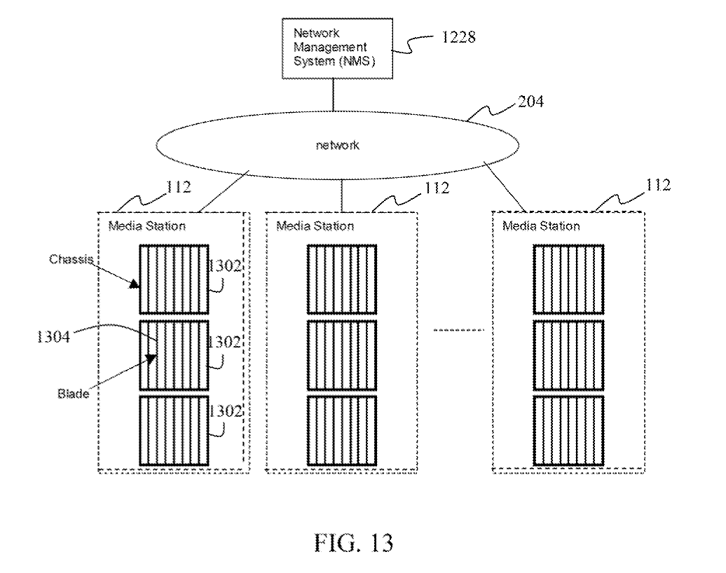

From the management point of view, each blade is a standalone computer. Besides its application functionalities, each blade has management software to monitor the health of the application software, system load and performance, as well as hardware related parameters such as CPU temperature, fan speed, and power supply voltage. The blade management software functionality is shown in FIG. 15.

The streaming application threads 1502 put their health and load information into a shared memory area periodically. The management monitor thread 1504 scans the area to analyze the status of the threads and the system. In addition to periodically reporting the state information to NMS through a SNMP agent 1506, appropriate actions as known in the art are taken when an abnormal state is detected.

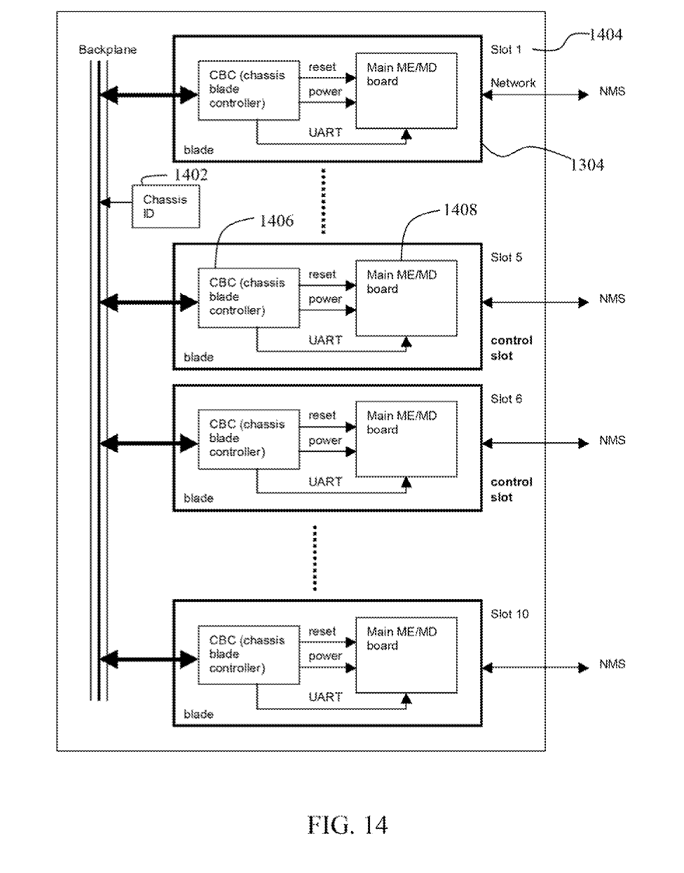

As previously described, a service token based authentication scheme is employed as the precursor for any data transfer requested by a subscriber's media console. FIG. 16 shows the access control schemes, where “sk” indicates a secrete key. Secret keys are established only between a system component, such as the media console 104 or the media station 112, and Authentication Server 1218. All other accesses among the system components are controlled by Kerberose style tokens granted by the Authentication Server. This reduces the number of secret keys distributed among the components, and makes adding new components simpler. An mc_token 1602 is passed by the media console to the media station to obtain streaming services. A cp token 1604 is passed by a media station for data transfer between media stations.

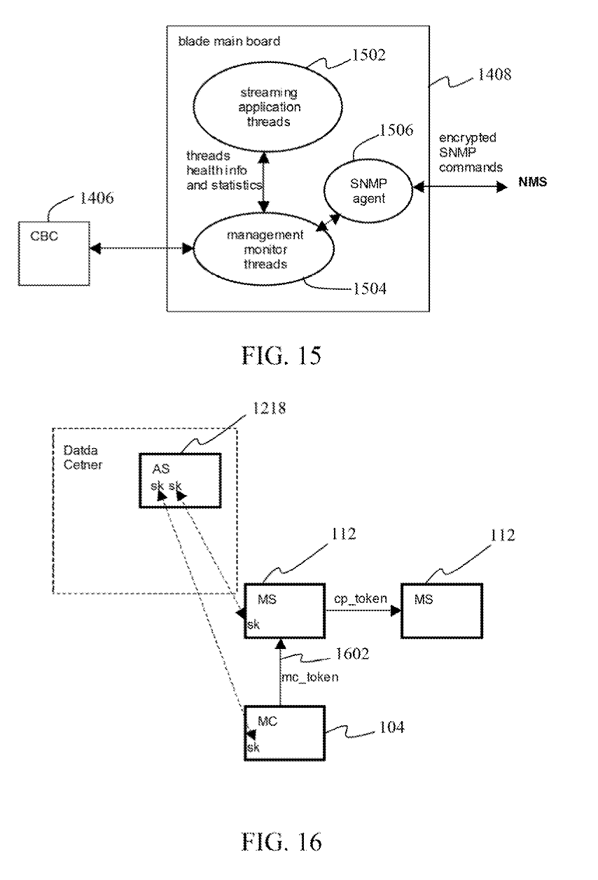

A media console possesses two numbers, MC_ID and MC_Key. Those numbers can be either burned into a chip in the box, be on a Smartcard, or be on some form of non-voltile memory in the box. When a subscriber signs up for the service, the Subscriber Management system records the numbers and associates them with the user account. MC_ID and MC_Key will be subsequently passed to the Authentication Server. FIG. 17 depicts the process of authentication.

A media console 104 when it powers up, after obtaining IP, sends an authentication request 1702 [which for the embodiment disclosed comprises MC_ID, {MC_ID, MC_IP, Other info, salt, checksum}_MC_Key] to the Authentication Server 1218. Note: {x}_k denotes that the message x is encrypted by k.

The Authentication Server finds the record of the media console using MC_ID, decrypts the message, and generates a session key, MC_SK, and an access_token for the media console. For an exemplary embodiment access_token={MC_SK, service code, timestamp, checksum}_MS_SK, where MS_SK is a secret key established previously between the authentication server and the media station that serves the media console; “service code” indicates what services the token can be used for. The Authentication Server calculates the “seed key” for MC_SK. The Authentication Server replies 1704 to the media console with [{access_token, MS_IP, salt, checksum}_MC_Key]. The MC decrypts the message with MC_Key and obtains mc_token and the IP address of the Media Director that it should contact. The mc_token will be kept until the media console shuts down, or the Authentication Server sends a new one. The media console sends 1706 mc_token to the application Server in the media station when requesting a media program, or the EPG server for browsing the EPG.

Middleware Application Programming Interfaces (APIs) are the enabling service functions which facilitate interaction between the media console or IPTV terminal and other content distribution network components. These services employ an open standard program interface, and can be used on different OS and hardware platforms. A middleware API module can be implemented based on various modes, but its basic function is to isolate applications from resources. Any application developed according to a specific middleware and its API can run on that middleware.

Middleware APIs are based on modularized software components. Corresponding middleware functions are implemented through a transplantable sub-layer to call OS resources, drivers and lower layer hardware resources. At the same time, the middleware core modules provide various services to upper application layer, including all services related protocols and service implementation at a client media console, such as media play and control, media stream transmission control, user authentication, system resource management, download service and security management as exemplary functions.

An application is an integration of service functions of the middleware API. The middleware API module isolates the application from the hardware and operation system, enabling portability of the application. The embodiment disclosed herein defines the middleware core module by function. The following are the defining functions: stream rendering and control by different sources; commands and events; User Authentication; system resources, such as file system, timer, etc; hardware resources, such as hard disk, memory, interface, and etc; network and transport protocol management; DRM and security management; startup and initialization; processes for security and authentications; software download and upgrades. Function of the middleware API is also extendable through use of a UltraWideBand (UWB) or WiFi chip in the media console capable of distributing content to a UWB or WiFi enabled home remote programmable device such as a PC or game controller, which operates with similar API stack to enable content distribution over dissimilar media to non-network controlled devices. Elements of the API can be distributed or derived from the signal distribution thus enabling applications at the remote programmable device to interact with the network at some or all of the API layers.

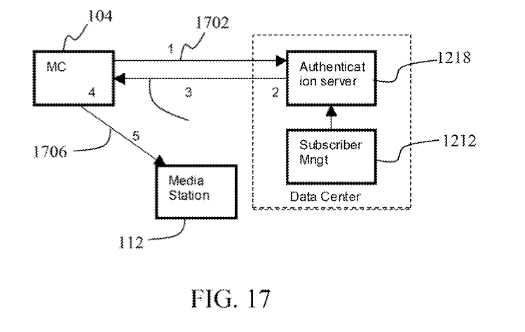

Exemplary API modules for the media content distribution system described are shown in FIG. 18.

For the embodiment disclosed herein a Security and Authentication management API module 1802 is provided. The module is responsible for the security mechanism of whole system, including subscriber authentication, network security, software upgrade, and service application security, etc. Its main functions include Subscriber authentication; Service application authorization; Software upgrade and download authentication; Network security policy; Key and token management.

When the media console or IPTV terminal signs on to the content distribution system, the security and authentication management module initiates an IPTV terminal install procedure and subscriber authentication procedure. At the same time, through this procedure, the IPTV terminal receives and manages a corresponding key and token from system as previously described.

When the IPTV terminal upgrades and download software, the security and authentication management module authenticates the software. The user performs a Digital Signature for the application software, and the security and authentication management module checks the Digital Signature and ensures application was not changed. If the application software has not been verified with a digital signature, it will have only basic rights running in the IPTV terminal.

As shown in FIG. 18, an upgrade and download API module 1804 is responsible for dynamic downloading or upgrading system and application software, devices of the resource layer, including middleware software, application software and certain specialty data requested by an IPTV application, such as EPG data, etc. The upgrade and download module provides the capability to dynamically upgrade and download system software and devices of resource layer; to dynamically upgrade and download application software and extended service applications; to dynamically upgrade and download metadata and presentation layer data used by applications; and to work together with the security and authentication management module to check validity of software and data;

A media play and control module 1806 is the streaming service controller. It provides media control and stream service operation functions for upper layer applications, such as play, pause, stop, fast forward, rapid return, etc. It is mainly responsible for screening signalling alternation and media implementation procedures of media console or IPTV terminal and media deliver system, and provide the API interface for upper applications. Consequently, media encapsulation format and signalling alternation procedure are not required by the applications. This module includes functions to create media stream control session, and be responsible for service control procedure of Video on Demand (VOD), multicast live TV, unicast live TV, and time shift; receive and decode media stream; media control, including play, stop, pause, resume, and other trick functions; media buffer management; trigger DRM process; hot key, stream control event and command handling; and Personal Video Recorder (PVR) control command;

A Digital Rights Management (DRM) API Module 1808 provides an unattached interface for upper layer applications, and admits applications to access the DRM system. The low layer DRM module will transparently process right control messages and right management messages, so the DRM module screens the difference between different DRM elements or systems. The DRM module in the exemplary embodiment includes the functions for license management; key management; and decrypting the media stream and data stream.

A terminal management API module 1810 provides IPTV terminal management and configuration functions such as local configuration, remote management, log management, version upgrade, exception management, security management, and Quality of Service policy management, etc. This detail management function includes management and configuring of the IPTV terminal through SNMP or TR069; Command Line Interface (CLI) engine; module and function configuration; system configuration such as various server address, etc; access mode configuration; Audio visual (A/V) parameter configuration; and subscriber configuration such as ADSL access account or IPTV account.

An Information display and control API module 1812 is responsible for providing a user interface (UI) engine for application and receiving, processing and dispatching some special events of the content distribution system from middleware modules to applications. These events include keyboard events, mouse events and remote controller events, including applications on the media console or remote devices communicating through the media console such as the UWB/WiFi enabled home remote programmable device previously described. This API module supports the functionality to receive Information (Price, Program, Metadata, Instant Message, and etc) from the content distribution system and to receive Information from media console remotes (subscribers).

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A media content distribution system for distributed multimedia streaming comprising:
a communications network including means for pushing media content;
a plurality of independent media stations communicating with the network, each having means for storing pushed media content locally, means for retrieving remotely stored media content over the network as pulled content and means for streaming media content over the network, means for directing a content request from a media console connected to the network for streaming from stored content;
means for measuring efficiency of pushed and pulled content.

2. A media content distribution system as defined in claim 1 wherein the means for measuring efficiency includes:
means for measuring number of requests satisfied by pushed contents;
means for measuring number of requests satisfied by pulled contents; and
means for measuring number of unsatisfied requests for locally present contents.

3. A media content distribution system as defined in claim 2 wherein the means for measuring efficient further includes means for measuring number of requests satisfied by pulling remote contents;
means for measuring number of unsatisfied requests for remote contents; and
means for calculating the number of requests for remote contents.

4. A media content distribution system as defined in claim 2 further comprising:
means for measuring number of push sessions; and
means for calculating the efficiency of push session as a ratio of number of requests satisfied by pushed contents and the number of push sessions.

5. A media content distribution system as defined in claim 3 further comprising:
means for measuring the number of pull sessions; and
means for calculating an efficiency of pull sessions as a ratio of number of requests satisfied by pulling remote contents and the number of push sessions.

6. A media content distribution system as defined in claim 1 wherein the means for measuring efficiency includes means for measuring a number of pulled bytes;
means for measuring a number of pushed bytes;
means for measuring a number of served bytes; and
means for calculating an efficiency of push/pull as a ratio of the sum of the number of pulled bytes and the number of pushed bytes to the number of served bytes.

7. A method for efficiency measurement in a media content distribution system having a communications network including means for pushing media content and a plurality of independent media stations communicating with the network, each having means for storing pushed media content locally, means for retrieving remotely stored media content over the network as pulled content and means for streaming media content over the network, means for directing a content request from a media console connected to the network for streaming from stored content comprising the steps of:
measuring number of requests satisfied by pushed contents;
measuring number of requests satisfied by pulled contents; and
measuring number of unsatisfied requests for locally present contents.

8. A method as defined in claim 7 further comprising the steps of:
measuring number of requests satisfied by pulling remote contents;
measuring number of unsatisfied requests for remote contents; and
calculating the number of requests for remote contents.

9. A method as defined in claim 7 further comprising the steps of:
measuring number of push sessions; and
calculating the efficiency of push session as a ratio of number of requests satisfied by pushed contents and the number of push sessions.

10. A method as defined in claim 8 further comprising the steps of:
measuring the number of pull sessions; and
calculating an efficiency of pull sessions as a ratio of number of requests satisfied by pulling remote contents and the number of push sessions.

11. A method as defined in claim 7 further comprising the steps of:
measuring a number of pulled bytes;
measuring a number of pushed bytes;
measuring a number of served bytes; and
calculating an efficiency of push/pull as a ratio of the sum of the number of pulled bytes and the number of pushed bytes to the number of served bytes.

12. A media content distribution system for distributed multimedia streaming comprising:
a communications network including means for pushing media content;
a plurality of independent media stations communicating with the network, each having means for storing pushed media content locally, means for retrieving remotely stored media content over the network as pulled content and means for streaming media content over the network, means for directing a content request from a media console connected to the network for streaming from stored content;
a plurality of application programming interface (API) modules providing
means for Security and Authentication management;
means for upgrade and download;
means for media play and control;
means for Data Resource Management (DRM);
means for terminal management; and,
means for Information display and control.

13. A media content distribution system as defined in claim 12 wherein the API modules further enable content distribution over dissimilar media to non-network controlled devices.
